(19) United States
(12) Patent Application Publication
(10) Pub. No.: US 2010/0162625 A1
(43) Pub. Date: Jul. 1, 2010

(54) Biomass fast pyrolysis system utilizing non-circulating riser reactor

(75) Inventor: Kevin J. Mills, Navarre, FL (US)

Correspondence Address: Deirdra M. Meagher, 24 Mine Street, Flemington, NJ, 08822, US

(73) Assignee: Innovative Energy Global Limited

(21) Appl. No.: 12/319,091

(22) Filed: Dec. 31, 2008

(51) Int. Cl. C10J 3/68; B01J 19/00

(52) U.S. Cl. 48/76; 422/187

(57) ABSTRACT

A biomass fast pyrolysis system for conversion of biomass vegetation to synthetic gas and liquid fuels includes: a) a non-circulating riser reactor for pyrolysis of biomass vegetation feedstock utilizing a heat carrier, the non-circulating riser reactor being physically structured and adapted to have a rate of reaction of at least 8,000 biomass vegetation feedstock lbs/hr/ft², utilizing a ratio of heat carrier to biomass vegetation feedstock of about 7:1 to about 11.5:1, the riser reactor having a base input region at its bottom, a central reaction region and an output region at its top, the riser reactor including a cyclone disengager at its output region for separation of pyrolysis resulting char and heat carrier from the pyrolysis product gases, the cyclone disengager having an output downcomer and an output upcomer, the cyclone disengager output downcomer being connected to and feeding into a side combustor unit, the riser reactor being a non-circulating riser reactor in that the heat carrier is not returned directly to the riser reactor from the cyclone disengager and travels first down the cyclone disengager output downcomer to the side combustor unit; and, b) the side combustor unit for combusting pyrolysis resultant char and reheating the heat carrier the side combustor having a heat carrier downcomer connected to the base input region of the riser reactor.

### BACKGROUND OF INVENTION

a. Field of Invention

The invention relates generally to a biomass rapid pyrolysis system wherein the system uniquely includes a non-circulating riser reactor with a specialized side combustor unit, and hence, a system that does not circulate the heat carrier directly through the disengager back to the riser reactor.

b. Description of Related Art

The following patents are representative of the field pertaining to the present invention:

U.S. Pat. No. 7,374,661 B2 to Bridges et al. describes a method for thermally cracking a hydrocarbonaceous feed material using a combustion fuel fired furnace wherein at least part of the combustion fuel employed in the furnace is syngas.

U.S. Pat. No. 7,241,323 B2 to Serio et al. describes a solid waste resource recovery in space is effected by pyrolysis processing, to produce light gases as the main products (CH₂, H₂, CO₂, CO, H₂O, NH₂) and a reactive carbon-rich char as the main byproduct. Significant amounts of liquid products are formed under less severe pyrolysis conditions, and are cracked almost completely to gases as the temperature is raised. A primary pyrolysis model for the composite mixture is based on an existing model for whole biomass materials and an artificial neural network models the changes in gas composition with the severity of pyrolysis conditions.

U.S. Pat. No. 7,202,389 B1 to Brem describes A process for pyrolysis of carbonaceous material is carried out in a cyclone reactor which is fitted with enhanced filtering equipment. In addition the invention relates to the use of a cyclone fitted with a rotating filter as a pyrolysis reactor. By using a cyclone of the rotating separator type as a pyrolysis reactor, carbonaceous material, such as biomass, can effectively be converted in a product having excellent chemical properties and which product is free from particulate matter.

U.S. Pat. No. 6,767,375 to Pearson describes an apparatus for producing synthesis gas from a biomass feed in a closed, helical coil reactor fired by at least a natural gas fed burner. The reactor includes the helical coil disposed concentrically in the reactor vessel with a burner positioned at the bottom of the vessel with a burner positioned at the bottom of the vessel and a generally cylindrical heat shield, with the bottom end (facing the burner) being closed at the top of the vessel. The heat shield is concentrically disposed within the coil, and they are placed adjacent to, but spaced from, the sidewall of the vessel so that convective heat may flow upwardly and around the individual coils. The lower section of the coils are exposed to the direct heat of the burner. The placement of the burner and heat shield provide respective heating zones to facilitate and control the heat supplied to the biomass for pyrolysis, reduction of char and bringing the target synthesis gas to equilibrium. Advantageously, a pressurized mixing vessel for pressurized feed of the biomass to the reactor coil is coupled to the input of the reactor. Likewise, addition of a secondary reactor will enable greater flexibility in the operation of the reactor coil in respect to particular gas products which can be formed in the operating conditions to reach such product gas.

U.S. Pat. No. 5,961,786 to Freel et al. describes an invention generally relating to a new method and apparatus for the fast pyrolysis of carbonaceous materials involving rapid mixing, high heat transfer rates, precisely controlled short uniform residence times and rapid primary product quench in an upflow, entrained-bed, transport reactor with heat carrier solids recirculation. A carbonaceous feedstock, a non-oxidative transport gas and inorganic particulate heat supplying material are rapidly mixed in a reactor base section, then transported upward through an entrained-bed tubular reactor. A cyclonic hot solids recirculation system separates the solids from the non-condensable gases and primary product vapors and returns them to the mixer. Product vapors are rapidly quenched to provide maximum yields of liquids, petrochemicals, high value gases and selected valuable chemicals.

U.S. Pat. No. 5,853,548 to Piskorz et al. describes a thermolysis process for the production of volatiles for an external combustor or liquefaction of biomass solids in which specific and previously unrecognized conditions are employed. The thermolysis is carried out in a single fluidized bed of inert material operating at near atmospheric pressure, relatively low temperature, long solids and gas residence times and moderate heating rates. The distribution of the thermolysis products among, solid (char) and gases under these conditions is unique. The product effluent can be either quenched to produce a high liquid yield in addition to a low char yield or the volatile effluent can be used in either the same combustor or a second combustor to produce heat energy a particularly high efficiency system. In using a quencher, the quenched liquid is of similar composition to those obtained by so called fast pyrolysis processes of the prior art. The specified conditions are such as to allow production of liquids in high yields in an energy efficient manner. The low severity of the conditions in comparison with previous approaches allows simplified process design and scale-up leading to lower capital and operating costs as well as easier control.

U.S. Pat. No. 5,792,340 to Freel et al. describes an invention which generally relates to a new method and apparatus for the fast pyrolysis of carbonaceous materials involving rapid mixing, high heat transfer rates, precisely controlled short uniform residence times and rapid primary product quench in an upflow, entrained-bed, transport reactor with heat carrier solids recirculation. A carbonaceous feedstock, a non-oxidative transport gas and inorganic particulate heat supplying material are rapidly mixed in a reactor base section, then transported upward through an entrained-bed tubular reactor. A cyclonic hot solids recirculation system separates the solids from the non-condensible gases and primary product vapors and returns them to the mixer. Product vapors are rapidly quenched to provide maximum yields of liquids, petrochemicals, high value gases and selected valuable chemicals.

U.S. Pat. No. 5,728,271 to Piskorz et al. describes a thermolysis process for liquefaction of biomass solids in which specific and previously unrecognized conditions are employed. The thermolysis is carried out in a single fluidized bed of inert material operating at near atmospheric pressure, relatively low temperature, long solids and gas residence times and moderate heating rates. The distribution of the thermolysis products among liquid (bio-oil), solid (char) and gases under these conditions is unique. In particular, contrary to the prior art, both high liquid and low char yields are obtained. Furthermore the liquid is of similar composition to those obtained by so called fast pyrolysis processes of the prior art. The specified conditions are such as to allow production of liquids in high yields in an energy comparison with previous approaches allows simplified process design and scale up leading to lower capital and operating costs as well as easier control.

U.S. Pat. No. 5,605,551 to Scott et al. describes a high conversion of biomass, such as wood, sawdust, bark or agricultural wastes, to liquids is obtained by pyrolysis at short reaction times in a reactor capable of high heat transfer rates; the reactor being of the fluidized bed, circulating fluidized bed or transport type in which the conveying gas contains low and carefully controlled amounts of oxygen, allowing a reaction system with low concentrations of carbon monoxide or flammable gases with a resulting improvement in operating safety and potential improvements in thermal efficiency and capital costs. The oxidation steps may be carried out in one or two stages. The resulting liquid product may be used as an alternative liquid fuel or as a source of high-value chemicals.

U.S. Pat. No. 5,562,818 to Hendrick describes an FCC feed distributor which mixes fresh catalyst entering the riser with steam to cream a dense bubbling bed of catalyst. Fluidized catalyst rises from the dense bed around a conical section supported from the bottom of the riser. The conical section accelerates the catalyst by reducing the flow area into a small width annulus. As fast fluidized catalyst flows to the annulus, a diverter outwardly redirects an axially flowing feed stream to discharge feed radially into the catalyst as it flows by the annular section. A narrow width of the annular section provides good penetration of the catalyst stream by the feed to quickly and completely mix the catalyst and feed. A tapered conical section above the narrow annular section provides an extended region of increasing flow area that controls downstream acceleration of the gas and catalyst mixture by permitting expansion and preventing back mixing over the initial stages of the cracking reaction. This arrangement improves the uniformity of gas and catalyst contracting while reducing the amount of steam or other dispersion gas required to achieve good catalyst and feed contact.

U.S. Pat. No. 5,512,070 to Stats describes a two stage carbonizer which places as much heat as possible into the gas streams entering the carbonizer to drive off volatile matter and reduce tars and oils by thermal cracking which is enhanced by the addition of sorbent. The carbonizer operates as a fluidized bed with a combustor providing flue gas as one fluidizing medium and preheating air as the other. This allows the coal to be devolatilized and the tars and oils to be thermally cracked due to the direct contact with the coal and hot flue gas. The device is designed to operate at high pressures from about 12-20 atmospheres.

U.S. Pat. No. 5,464,591 to Bartholic describes the method of controlling the flow of a fluidizable particulate solid, e.g., FCC catalyst, which comprises: (a) passing a fluidized stream of the particulate solid downwardly from a source of the particulate solid, e.g., an FCC generator, in a first conduit to a junction with a second conduit where the solid particulate is mixed with a stream of a fluid transport medium from a third conduit; (b) passing a stream of the resulting mixed solid particulate/transport medium upwardly in the second conduit at an angle less than 90° from the first conduit for a distance at least as great as the diameter of the first conduit at the junction into a fourth conduit; (c) Transporting the particulate solid/fluid transport medium stream in the fourth conduit to a desired location; and (d) controlling the mass flow of the particulate solid in the fourth conduit by setting the flow rate of the transport medium in the third conduit. By determining the temperatures of the particulate solid in the first conduit, the transport medium in the third conduit and the particulate solid transport medium mixture, the mass flow of the particulate solid transport medium mixture, the mass flow of the particulate solid in the fourth conduit may be controlled by setting the flow rate of the transport medium in the third conduit. Apparatus for carrying out the method is also included.

U.S. Pat. No. 5,423,950 to Avetisian et al. describes a reactor that forms a chamber which contains the reaction process. There are accesses to the chamber for receiving shredded tires and oil. There are egresses from the chamber for discharging the tire oil and for discharging unreacted elements. Apparatus is located within the chamber which separates the unreacted components of the shredded tires from the tire oil. The apparatus also provides for the removal of the unreacted elements from the chamber means. The reactor also includes a heater which heats the inside of the chamber to a temperature sufficient to cause a reaction between the shredded tires and the oil.

U.S. Pat. No. 5,413,227 to Diebold et al. describes an improved vortex reactor system for affecting fast pyrolysis of biomass and Refuse Derived Fuel (RDF) feed materials comprising: a vortex reactor having its axis vertically disposed in relation to a jet of a horizontally disposed steam ejector that impels feed materials from a feeder and solids from a recycle loop among with a motive gas into a top part of said reactor.

U.S. Pat. No. 5,217,602 to Chan et al. describes a fluid catalytic cracking (FCC) process riser reactor in which effluent is rapidly separated into spent catalyst and hydrocarbon product. The separated hydrocarbon product is immediately quenched to an unreactive temperature in the absence of quenching spent catalyst. An increase in debutanized naphtha yield is achieved. By avoiding catalyst quenching, heat duty is saved in the catalyst generator.

U.S. Pat. No. 5,098,554 to Krishna et al. describes a fluid catalytic cracking unit equipped with multiple feed injection points along the length of the riser is operated such that all of the fresh feed is charged to one of different feed injection points, depending on the ratio of light distillate (gasoline) to middle distillate (light catalytic gas oil) that is desired in the product slate. When all of the fresh feed is charged to one of the upper injection points in the riser in order to increase middle distillate yield, the unconverted slurry oil (650° F.+material) can be recycled to a location below the injection point of the fresh feed so as to increase conversion to middle distillate while lowering the activity of the catalyst (via coke deposition) for single pass conversion of the fresh feed. Steam in excess of levels typically employed for dispersion is used at the bottom of the riser to lift the regenerated catalyst up to the feed injection points. Other inert gases can be used in place of or in conjunction with steam to accomplish lifting of catalyst in the riser.

U.S. Pat. No. 5,006,223 to Wiehe et al. describes the present invention which is predicated on the discovery of the addition of certain free radical initiators to thermal conversion processes results in increased thermal conversion rate at a given temperature without any substantial increase in the amounts of gaseous products formed. This permits operating the thermal conversion process at lower temperatures than otherwise practical. Indeed, the present invention is especially useful in thermal cracking processes like fluid coking. In this embodiment, a free radical initiator is added, without the addition of a hydrogen donor diluent, to a feedstock which is thermally cracked in a fluidized bed of the particulate solids and at lower temperatures than otherwise employed, thereby increased amounts of liquid products are obtained.

U.S. Pat. No. 4,968,325 to Black et al. describes a process and a plant for gasifying biomass. The plant has a pressure vessel containing a hot fluidized sand bed. The bio-mass is pre-dried to a moisture content of from 10% to 35% by weight. A stream-free oxygen-containing gas is fed and distributed, through a grid system at the bottom of the hot sand bed, to hold the bed in a fluidized state and to form, in its lower portion, an oxygen-rich heat-forming combustion zone and, in its upper portion, a hydrogen-rich gas-forming pyrolysis zone. The pre-dried biomass is uninterruptedly fed in the pyrolysis zone at essentially the center of the hot fluidized bed, this center being determined when the sand bed stands at rest. The fluidized bed is held at an operating temperature of 750° to 860° C. under an operating pressure of 400 kPa to 1750 kPa by controlling the feeding rate of the fluidized gas as well as the feeding rate of the biomass. The gases and biomass residue released from the hot fluidized bed are removed in a gas stream from the head space above the bed and sent to a primary cyclone which separates the useful gases from the most of the biomass residue the latter being returned to the combustion zone of the bed. The gases and the biomass residue that have remained in the first cyclone are then moved into a second cyclone where the useful gases are collected and the biomass residue discharged.

U.S. Pat. No. 4,946,581 to Van Broekhoven describes hydrocarbon conversion catalyst compositions, such as fluidizable cracking catalyst compositions, containing an anionic clay, e.g. a clay having a hydrotalcite, an ettringite or a hydrocalumite structure, for the conversion of sulphur oxides binding material. Also disclosed are absorbents containing the anionic clay embedded in a matrix. The absorbents may be used to purify sulphur oxides-containing gases.

U.S. Pat. No. 4,940,531 to Lussier describes acid reacted metakaolin useful for the preparation of catalyst and catalyst support compositions. The compositions may include solid inorganic oxides, such as zeolites, clay and/or inorganic gels. The compositions are spray dried and calcined to obtain highly active, dense, attrition resistant fluid cracking catalysts or used in the preparation of formed catalyst supports.

U.S. Pat. No. 4,931,171 to Piotter describes a process for the pyrolysis of carbonaceous materials at an elevated temperature or an elevated temperature and an elevated pressure in which a fuel is burned in the presence of a combustion supporting material, in an amount sufficient to supply at least the stoichiometric amount of oxygen for combustion of all of the fuel, to produce an effluent containing significant amounts of nitrogen and carbon dioxide and having an elected temperature, passing the effluent to a pyrolysis zone, without removal of components therefrom, to thereby create an elevated temperature within the pyrolysis zone and pyrolyzing the carbonaceous material in the pyrolysis zone in the presence of the effluent from the burning step and at an elevated temperature. The burning step may additionally be carried out at a high flame velocity to produce an effluent having an elevated pressure and the carbonaceous material may thus additionally be pyrolyzed at an elevated pressure.

U.S. Pat. No. 4,895,639 to Bellinger et al. describes in an ebullated bed process, a residual hydrocarbon oil and a hydrogen containing gas is passed upwardly through an ebullated bed of catalyst in a hydrocracking zone at a temperature in the range of 650° F. to 950° F. and pressure of 1000 psia to 5000 psia. FCCU catalyst fines are added to the ebullated bed in an amount of 15 wt % to 21 wt % of total catalyst comprising hydrocracking catalyst and fines. A hydrocracked oil is recovered characterized by having a reduced sediment content.

U.S. Pat. No. 4,828,581 to Feldmann et al. describes the present invention which discloses a novel method of operating a gasifier for production of fuel gas from carbonaceous fuels. The process disclosed enables operating in an entrained mode using inlet gas velocities of less than 7 feet per second, feedstock throughputs exceeding 4000 lbs/ft²-hr, and pressures below 100 psia.

Notwithstanding the prior art, the present invention is neither taught nor rendered obvious thereby.

### SUMMARY OF INVENTION

The present invention is biomass fast pyrolysis system for conversion of biomass vegetation to synthetic gas and liquid fuels. The system includes: a) a non-circulating riser reactor for pyrolysis of biomass vegetation feedstock utilizing a heat carrier, the non-circulating riser reactor being physically structured and adapted to have a rate of reaction of at least 8,000 biomass vegetation feedstock lbs/hr/ft², utilizing a ratio of heat carrier to biomass vegetation feedstock of about 7:1 to about 11.5:1, the riser reactor having a base input region at its bottom, a central reaction region and an output region at its top, the riser reactor including a cyclone disengager at its output region for separation of pyrolysis resulting char and heat carrier from the pyrolysis product gases, the cyclone disengager having an output downcomer and an output upcomer, the cyclone disengager output downcomer being connected to and feeding into a side combustor unit, the riser reactor being a non-circulating riser reactor in that the heat carrier is not returned directly to the riser reactor from the cyclone disengager and travels first down the cyclone disengager output downcomer to the side combustor unit; and, b) the side combustor unit for combusting pyrolysis resultant char and reheating the heat carrier the side combustor having a heat carrier downcomer connected to the base input region of the riser reactor.

In some preferred embodiments of the present invention biomass fast pyrolysis system for conversion of biomass vegetation to synthetic gas and liquid fuels, the input region of the riser reactor includes separate biomass vegetation feedstock input and mixing gas input feedlines.

In some preferred embodiments of the present invention biomass fast pyrolysis system for conversion of biomass vegetation to synthetic gas and liquid fuels, the biomass vegetation feedstock input feedline is located downstream from the mixing gas input feedline.

In some preferred embodiments of the present invention biomass fast pyrolysis system for conversion of biomass vegetation to synthetic gas and liquid fuels, the synthetic gas input feedline is a manifolding feedline with a plurality of inputs.

In some preferred embodiments of the present invention biomass fast pyrolysis system for conversion of biomass vegetation to synthetic gas and liquid fuels, the riser reactor has a predetermined maximum internal diameter with a height at least 10 times greater than the predetermined maximum internal diameter.

In some preferred embodiments of the present invention biomass fast pyrolysis system for conversion of biomass vegetation to synthetic gas and liquid fuels, the cyclone disengager contains a plurality of cyclones.

In some preferred embodiments of the present invention biomass fast pyrolysis system for conversion of biomass vegetation to synthetic gas and liquid fuels, the cyclone disengager contains a plurality of cyclones coupled such that exiting gases will pass sequentially through at least two cyclone units before exiting.

In some preferred embodiments of the present invention biomass fast pyrolysis system for conversion of biomass vegetation to synthetic gas and liquid fuels, the side combustor unit is selected from the group consisting of a transport reactor combustor unit and a bubbling bed combustor unit.

In some preferred embodiments of the present invention biomass fast pyrolysis system for conversion of biomass vegetation to synthetic gas and liquid fuels, the side combustor unit is a transport reactor combustor unit.

In some preferred embodiments of the present invention biomass fast pyrolysis system for conversion of biomass vegetation to synthetic gas and liquid fuels, the side combustor unit is a transport reactor combustor unit and the cyclone disengager includes a surge control subunit at the cyclone disengager output downcomer.

In some preferred embodiments of the present invention biomass fast pyrolysis system for conversion of biomass vegetation to synthetic gas and liquid fuels, the side combustor unit is a bubbling bed combustor unit.

In some preferred embodiments of the present invention biomass fast pyrolysis system for conversion of biomass vegetation to synthetic gas and liquid fuels, the side combustor unit is a bubbling bed combustor unit including a lower combustion region and an upper freeboard region, the freeboard region including a plurality of cyclones with at least one output upcomer for exhaust, the combustor unit further including a preheated gas inlet at its combustion region and the combustor unit having a combustion unit downcomer connected to the input region of the riser reactor from the lower combustion region.

In some preferred embodiments of the present invention biomass fast pyrolysis system for conversion of biomass vegetation to synthetic gas and liquid fuels, the freeboard region of the bubbling bed combustor unit contains a plurality of cyclones with outputs coupled such that exiting gases will pass through at least two cyclone units before exiting.

In some preferred embodiments of the present invention biomass fast pyrolysis system for conversion of biomass vegetation to synthetic gas and liquid fuels, includes: a) a non-circulating riser reactor for pyrolysis of biomass vegetation feedstock utilizing a heat carrier, the non-circulating riser reactor being physically structured and adapted to have a rate of reaction of at least 8,000 biomass vegetation feedstock lbs/hr/ft², utilizing a ratio of heat carrier to biomass vegetation feedstock of about 7:1 to about 11.5:1, the riser reactor having a base input region at its bottom, a central reaction region and an output region at its top, the riser reactor including a cyclone disengager at its output region for separation of pyrolysis resulting char and heat carrier from the pyrolysis product gases, the cyclone disengager having an output downcomer and an output upcomer, the cyclone disengager output downcomer being connected to and feeding into a side combustor unit, the riser reactor being a non-circulating riser reactor in that the heat carrier is not returned directly to the riser reactor from the cyclone disengager and travels first down the cyclone disengager output downcomer to the side combustor unit; and, b) the side combustor unit for combusting pyrolysis resultant char and reheating the heat carrier the side combustor having a heat carrier downcomer connected to the base input region of the riser reactor; and, c) separate biomass input feedline and mixing gas input feedline, wherein the biomass input feedline connected to the input region of the riser reactor includes back pressure control means to prevent pressure release from the riser reactor during operation. In these embodiments, any of each or combination of the other embodiments described in paragraph [00028] to [00039] may also be included.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention and are incorporated in and constitute a part of this specification, illustrate preferred embodiments of the invention and together with the detail description serve to explain the principles of the invention. In the drawings:

FIG. 1 is an overview block diagram of the present invention biomass fast pyrolysis system;

FIG. 2 is a detailed block diagram of a present invention preferred embodiment biomass fast pyrolysis system;

FIG. 3 is another detailed block diagram of a present invention preferred embodiment biomass fast pyrolysis system;

FIG. 4 is a side transparent view of a preferred embodiment of the present invention biomass fast pyrolysis non-circulating riser reactor;

FIG. 5 is a top view of a present invention biomass fast pyrolysis system riser reactor cyclone;

FIG. 6 is a top view of a present invention biomass fast pyrolysis system side combustor cyclone; and, view of a present invention system fast pyrolysis riser reactor illustrating an accelerator configuration with a feed gas manifold;

FIG. 7 is a partial front view of a lower portion (base input region) of a present invention biomass fast pyrolysis system riser reactor;

FIGS. 8a and 8b are detailed process flow diagrams of another present invention preferred embodiment biomass fast pyrolysis system utilizing a bubbling bed combustor unit; and,

FIGS. 9a and 9b are detailed process flow diagrams of another present invention preferred embodiment biomass fast pyrolysis system utilizing a transport reactor combustor unit.

### DETAILED DESCRIPTION OF THE EMBODIMENTS

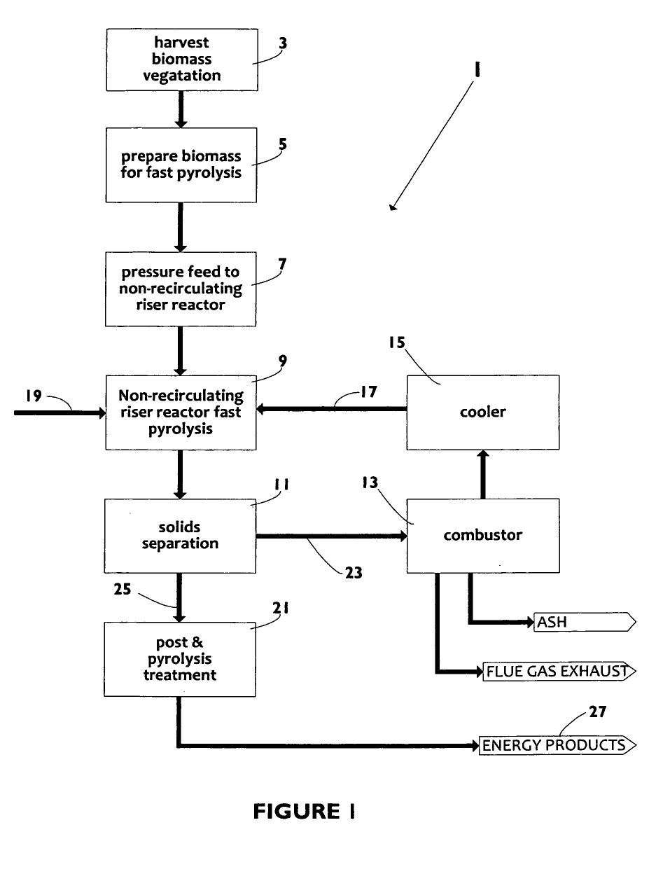

FIG. 1 is an overview block diagram of the present invention biomass vegetation fast pyrolysis system wherein the overall process is designated as system 1. In order to proceed with the present invention biomass vegetation fast pyrolysis process, the biomass vegetation must be harvested, block 3, and properly prepared, block 5. The biomass vegetation may be harvested anywhere in the world and it may be any natural or hybrid vegetation product, but various types of biomass vegetation feedstock are more efficient than others. For example, various types of cane grass, sometimes referred to as biograss or e-grass, may be harvested 1 or more times per year and have very high BTU values. Fibergrass (Arundo Donax) cane is one preferred type of biomass.

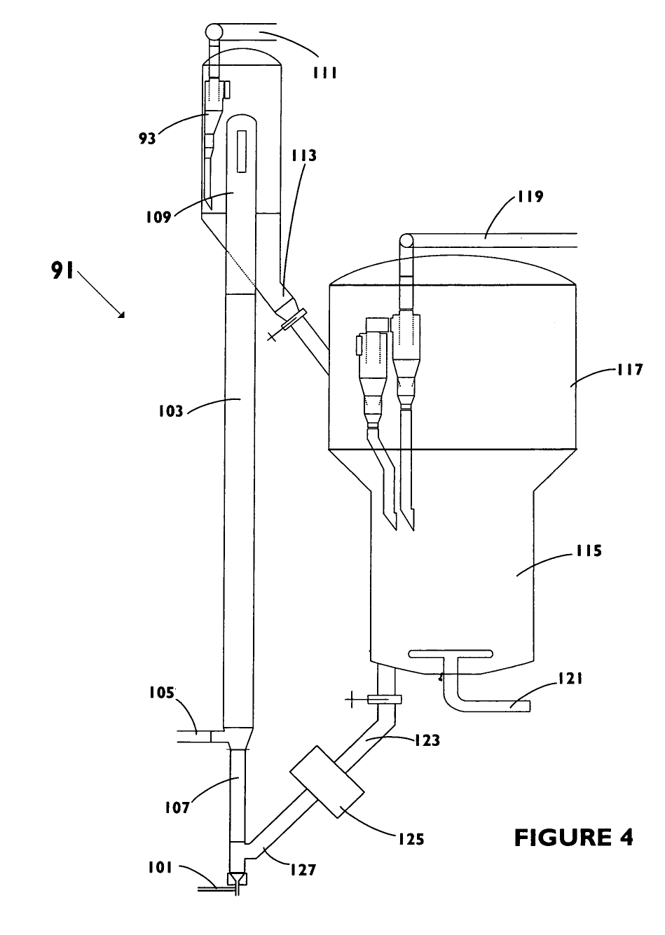

Preparation of the biomass vegetation, block 5, for the present invention fast pyrolysis, involves significant size reduction through grinding and/or pulverization. Also, for relatively damp biomass, predrying to control moisture content may be necessary. The prepared biomass vegetation is pressure fed, block 7, into a non-circulating riser reactor, block 9. Pressure feeding the biomass vegetation is necessary to inhibit back pressure during the fast pyrolysis. A fast pyrolysis non-circulating riser reactor such as the ones described in conjunction with the figures below, such as the one in FIG. 4, is utilized in conjunction with the FIG. 1 overview block diagram present invention system (this essential type of non-circulating riser reactor is discussed in further detail below.) The fast pyrolysis, block 9, occurs within the riser reactor. Mixing gas is used to enhance the mixing and flow of the biomass vegetation feedstock and this mixing gas may be an inert gas, such as nitrogen, recycled syngas from the products of the process, combinations of these or other non-oxidizing mixing gas or gases. Mixing gas feed, line 19, is fed to the fast pyrolysis riser reactor along with a heat carrier, line 17, and combines with the biomass vegetation feed, block 7, to yield gases, liquids and solids at the upper region of the riser reactor. Solids separation, block 11, is utilized to remove heat carrier and char, line 23, to yield gases and liquids, line 25, including syngas and liquid fuels for post treatment, block 21, from which desired energy products, line 27, are obtained.

In the present invention system, the heat carrier solids are not directly recirculated to the riser reactor after separation from the off-gases. Instead, the heat carrier solids and char, line 23, are sent to a side combustor, block 13. The heat carrier feed, after combustion, is cooled in a cooler unit, block 15, such as a heat exchanger, and then fed to the fast pyrolysis riser reactor, block 9, for re-use, via line 17. The combustor is used to eliminate the char and clean the heat carrier before reuse in the riser reactor. This feature assists in producing faster yields with lower ratios of heat carrier to biomass vegetation feedstock of about 7:1 to about 11.5:1, while being physically structured and adapted to have a very high rate of reaction, a rate of reaction of at least 8,000 biomass vegetation feedstock lbs/hr/ft² and even 10,000 lbs/hr/ft² to 15,000 lbs/hr/ft² and higher.

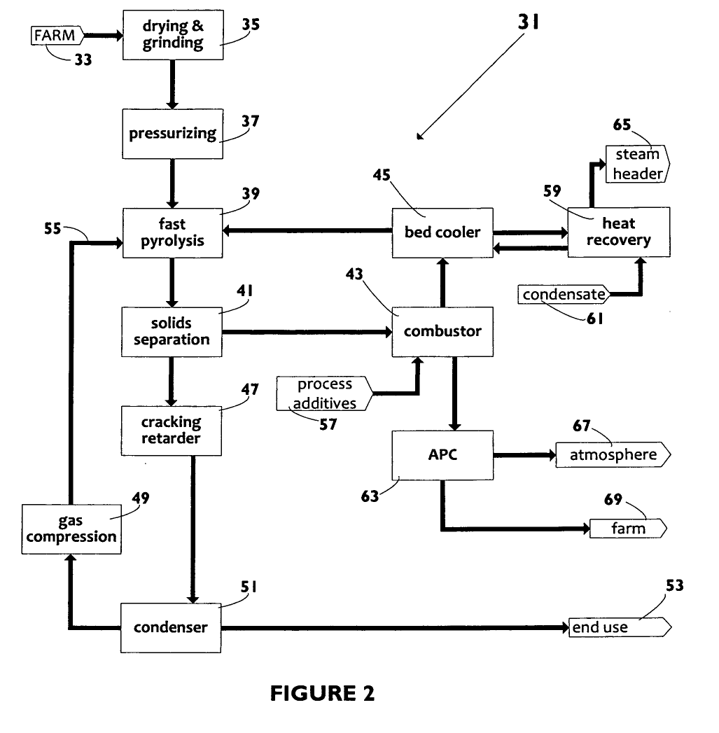

FIG. 2 is a detailed block diagram of one present invention preferred embodiment biomass fast pyrolysis system 31. In this embodiment, biomass vegetation, such as egrass, is grown and harvested in the region of or adjacent a production plant utilizing the present invention system 31. The biomass vegetation is harvested from farm, block 33, is dried and ground, block 35. The prepared biomass vegetation is pressurized, block 37, and fed into the non-circulating riser reactor for fast pyrolysis, block 39. As mentioned previously, pressure feeding the biomass is utilized to inhibit back pressure during the fast pyrolysis and to promote mixing by reducing the spacing between particles. A fast pyrolysis non-circulating riser reactor, such as the one described in FIG. 4 below, is utilized in conjunction with this FIG. 2 system 31. (This type of non-circulating riser reactor is essential to the invention and is discussed in further detail below.) The fast pyrolysis, block 39, occurs within the riser reactor. Syngas feed and heat carrier material are fed separately into the fast pyrolysis riser reactor to yield gases, liquids and solids at the upper region of the riser reactor. The products from the top of the pyrolysis reactor are processed through a disengager for solids separation, block 41.

Solids separation, block 41, is utilized to remove heat carrier and char from the desired products to yield the product gases and liquids, including syngas and liquid fuels, for post-pyrolysis treatment. In this particular process, gases from the solid separation step, block 41, are fed to a cracking retarder, block 47, and then to a condenser, block 51. From the condenser, products for end use 53 are removed and selected recycled gases are moved to gas compression unit, block 49, and are recycled back to the fast pyrolysis riser reactor at gas fee, line 55.

In the present invention systems, including as shown in FIG. 2, the heat carrier solids are not directly circulated to the riser reactor after separation from the off-gases. Instead, the heat carrier solids and char are sent to a combustor, block 43. The bed carrier feed, after combustion, is cooled in a bed cooler, block 45, and is then fed to the fast pyrolysis riser reactor, block 39, for re-use. The combustor is advantageously utilized to eliminate the char and clean the heat carrier before reuse in the riser reactor. Process additives, block 57, such as anti-glassing agents, may be added to the combustor, block 43, to reduce bed agglomeration. Essentially, the heat recovery unit, block 59, recycles condensate, block 61, and other liquids for cooling. Off-liquids from process passing through the bed cooler, block 45, are delivered to a heat use recovery unit, block 59, and enter the APC (air pollution control unit), block 63. Here, filtered exhaust is released to the atmosphere, block 67, and liquids (with nutrients) are recycled to the farm for irrigation and possible fertilizer, block 69.

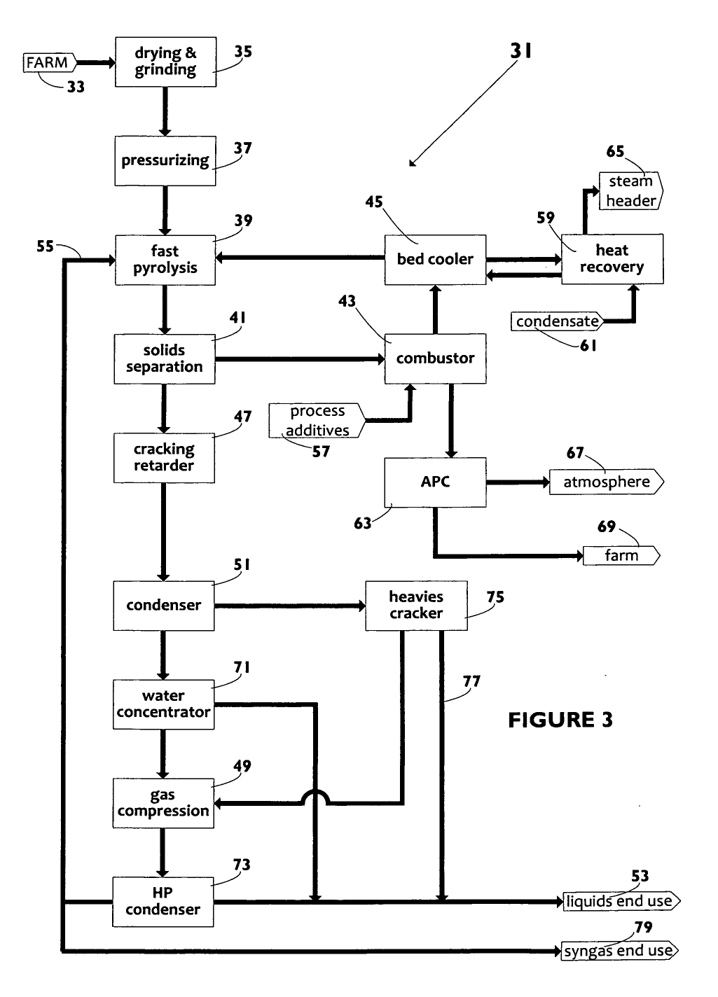

FIG. 3 is another detailed block diagram of a present invention preferred embodiment biomass fast pyrolysis system. In many aspects, it is the same as that shown in FIG. 2, and, hence, identical components are identically numbered and the details of these from the preceding paragraphs are incorporated herein. Changes and additions thereto are now described. In this embodiment, when the product is moved from the cracking retarder, block 47, to the condenser, block 51, it then takes a different course of processing steps. From the condenser, block 51, liquids are delivered to heavies recracker, block 75, and bottoms of the cracked heavies product, line 77, are, in part, recycled to gas compression, block 49, and, in part, are taken for liquids end use, block 53. The gases from the condenser, block 51, are delivered to water concentrator, block 71. Some of the water concentrator products, block 71, are sent to liquid end use, block 53, while bottoms from the water concentrator are fed to gas compression, block 49, and to high pressure condenser 73. Syngas outputs from the high pressure condenser, block 473, go to syngas end use, block 79, and some syngas, line 55, is recycled to the fast pyrolysis reactor.

This FIG. 3 embodiment operates more efficiently than the FIG. 2 approach when specific mixes and products are preferred, e.g., a bias toward higher grade fuels. The additional steps provide for micro management of the cracking, resulting products and mix ratios to customize the end products.

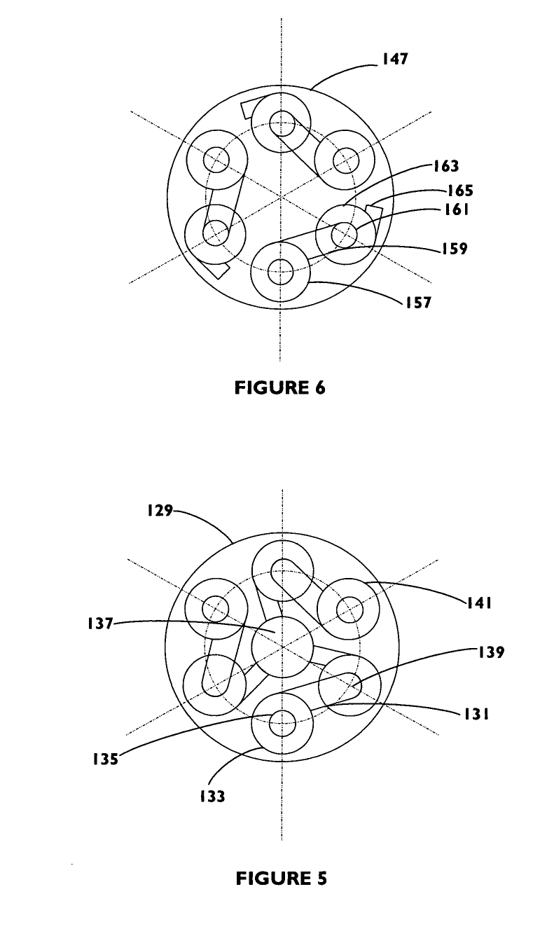

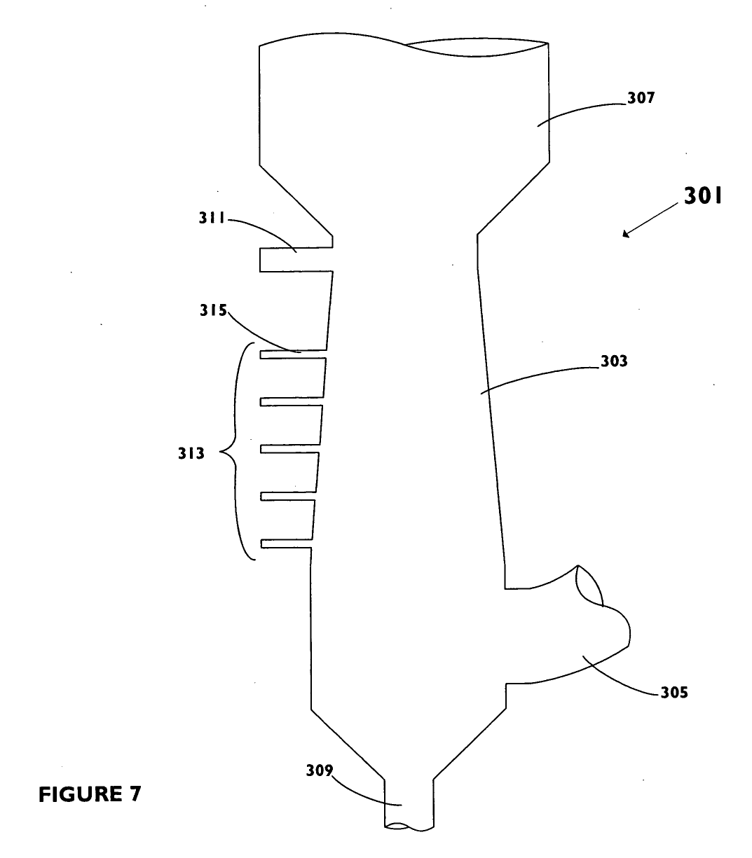

In conjunction with the FIG. 1 present invention system, as well as in conjunction with each of those described in FIGS. 2 and 3, one preferred present invention biomass fast pyrolysis system riser reactor is shown in FIG. 4. FIG. 4 illustrates a side, transparent view of a present invention non-circulating riser reactor 91. Riser reactor 91 includes a main reactor tube with a central reactor region 103, a base input region 107 and an output region 109 at its top. The disengager 93 preferably contains a plurality of cyclones that may advantageously be arranged such as is shown and described with respect to FIG. 5 below. The lower area, that is, base input region 107 includes a biomass feedline 105 and a single or plural gas input line 101. A preferred gas is syngas, especially syngas recycled from the system itself. In many present invention preferred embodiments, the gas input line is a manifold gas input line such as that shown in FIG. 7 below.

The syngas entering through feedline 101 picks up the incoming bed carrier from feedline 127 and intermixes with the biomass fines. The mixture rises into the central reaction region 103 to temperatures in the 700 to 1610° F. range where the pyrolysis reaction converts the biomass to shorter chain fuel products to diverse boiling points. When the mixture rises to output region 109, it enters disengager 93, with its plurality of cyclones arranged in accordance with FIG. 5 below. Syngas passes through the cyclones and exits through syngas exit line 111 for further processing. Solids and chars exit the disengager at out put downcomer 113. Downcomer 113 feeds the solids to combustor 115. It preferably employs a plurality of cyclones in a specified arrangement.

Combustor 115 has an upper region that is a freeboard region and an exhaust exit line 119 for exiting off-gasses. The freeboard region 117 preferably includes a plurality of cyclones such as set forth in FIG. 6 below, for off-gas exhaust. Combustion gases enter combustor 115 via inlet 121 to increase temperatures to as high as 1600° F. to eliminate char and to clean the bed carrier material. Exiting solids, predominantly bed carrier materials, exit through exit line 123 to bed cooler 125 and then to bed carrier feedline 127 of the riser reactor 91.

FIG. 5 is a top view of a present invention biomass fast pyrolysis system riser reactor cyclone array 129. Cyclone array 129 represents one preferred embodiment of an arrangement that could be incorporated into a present invention fast pyrolysis reactor such as that shown in FIG. 4 above, particularly in disengager 93 of FIG. 4. As can be seen in this top view, pairs of cyclones are connected in a downward cascade, such as lower cyclone 141 connected at its top exit 139, via connector 131, to upper cyclone 133 with top exit 135. This array 129, with central exit 137, is particularly advantageous for efficient removal of char and solids catalyst (bed carriers).

FIG. 6 is a top view of a present invention biomass fast pyrolysis system side combustor cyclone array 147. Cyclone array 147 represents one preferred embodiment of an arrangement that could be incorporated into a present invention reactor side combustor such as that shown in FIG. 4 above, particularly in freeboard region 117 of disengager 115 of FIG. 4. As can be seen in this top view, pairs of cyclones are connected in an upward cascade, such as lower cyclone 163 with inlet 165 and with it being connected at its top exit 161, via connector 159, to upper cyclone 157 with top exit 135. This array 147 is particularly advantageous for efficient reduce of char and cleaning of solids catalyst (bed carriers) before being returned to the bottom region of the fast pyrolysis reactor.

FIG. 7 is a partial front view of greater detail of a lower portion (base input region) 301 of a present invention biomass fast pyrolysis system riser reactor such as that shown in FIG. 4. This shows an accelerator configuration 303 upwardly constricting and then opening into main riser reactor tube 307. Lower portion 301 also includes a feed gas manifold 313. An underfed fluidizing gas inlet 309 is also included. Manifold 313 has a plurality of syngas (or equivalent) input ports, such as input port 315. These may preferably be arranged in an ascending or descending circle and be pitched to create a swirling effect internally and to assist in even and complete mixture of the incoming carrier materials (input port 305), the syngas and the biomass feedstock (input port 311).

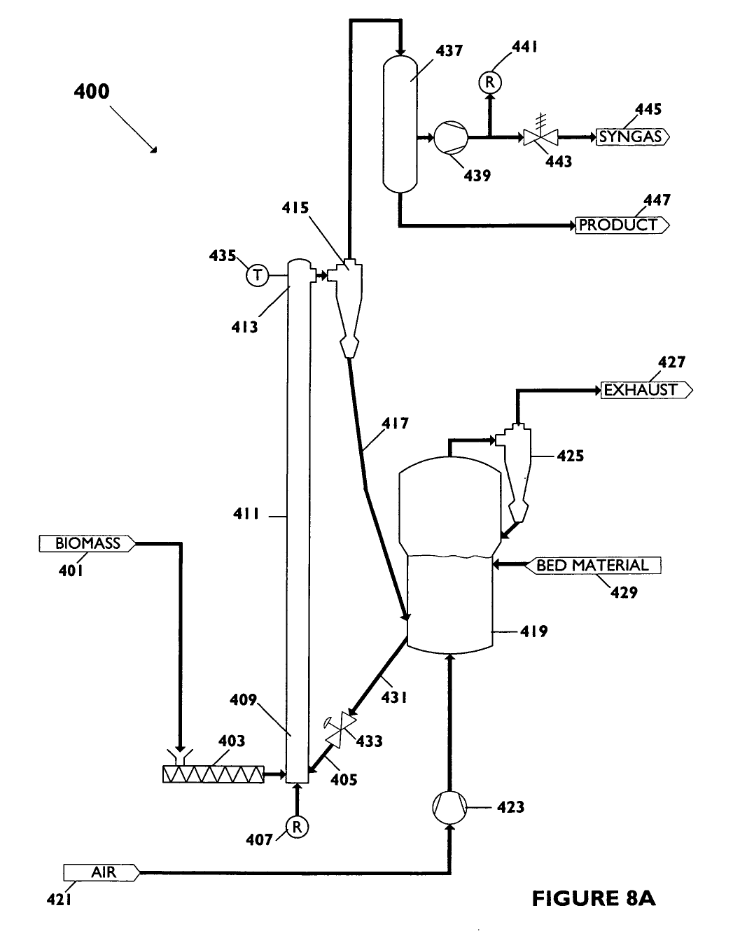

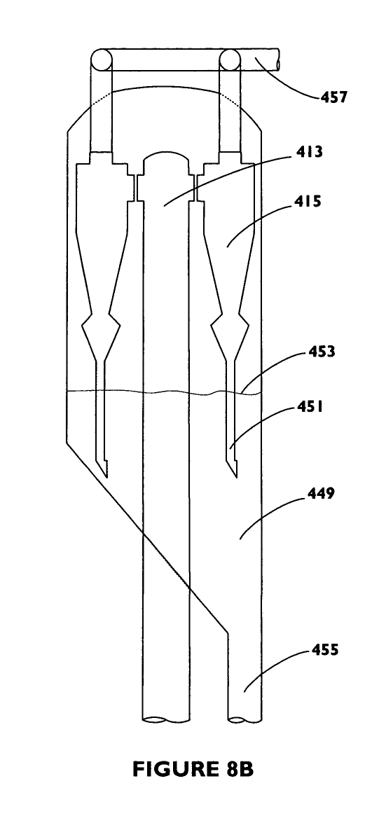

FIG. 8a is a process flow diagram of the present invention preferred embodiment biomass fast pyrolysis system 400. Biomass vegetative material 401 is harvested and brought to the process in a chipped form. This material is screw fed 403 into the non-recirculating riser reactor lower section 409 where it is contracted by hot heat carrier solids 405 which are fluidized by compressed syngas 407. The rapid heat up of the biomass vegetative material causes the release of its volatile gases which transport the resulting char and heat carrier solids up the non-recirculating riser reactor 411. These solids laden pyrolysis gases exit riser reactor upper section 413 to one or more cyclones 415. The cyclone(s) 415 separate(s) the char and heat carrier solids from the pyrolysis gases, conveying the char laden heat carrier stream 417 to the char combustor 419. A blower 423 is used to deliver compressed air 421 to the char combustor where the combustion of the char takes place leaving an ash particulate and thus reheating the heat carrying solids. Char combustor cyclones 425 are used to separate the resultant ash and heat carrier fines from the heat carrier stream. The resultant ash laden flue gases are exhausted from the process in stream 427. Make-up heat carrier 429 is added to the char combustor to replenish the fines lost in the char combustor cyclone exhaust. The reheated heat carrier solids are returned by the downcomer 431 and flow controlled by a slide gate valve 433, used to control the non-recirculating riser reactor exit temperature 435.

The pyrolysis gases exiting the riser cyclone 415 are cooled in condenser 437 to condense out a liquid product stream 447 and syngas. The syngas is compressed in compressor 439, recycling a controlled portion 439 back to the non-circulating riser reactor lower section where it fluidizes the heat carrier solids entering this section. A pressure regulating valve 443 is used to control system pressure, allowing the syngas to be exhausted as a product stream 445. A controlled portion of the remaining syngases (stream 441) is recycled back to the non-recirculating riser reactor lower section 409.

FIG. 8b shows a disengaging vessel 449, which is required if multiple cyclones were incorporated for FIG. 8a. This vessel is attached to the top of the riser 413. Multiple cyclones 415 are radially connected to the top of the riser. Each of the cyclone diplegs 451 is submerged below the solids level 453 in the lower section of the disengaging vessel. The lower section acts as a hopper for the heat carrier and char solids, discharging to a common downcomer 455. Each of the cyclone upflow gas exhausts are connected to a common pyrolysis gas duct 457.

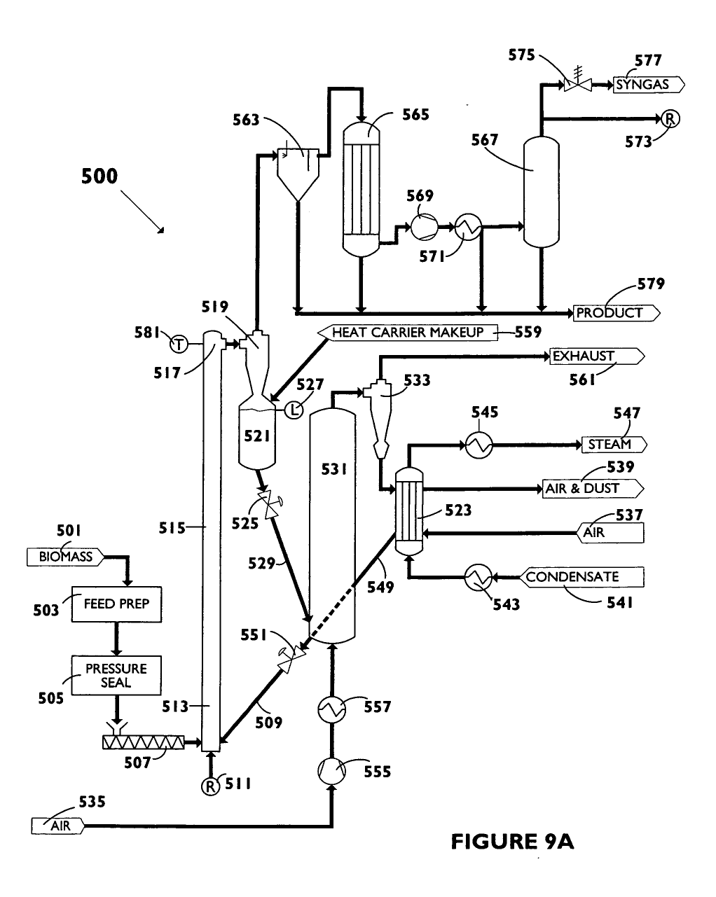

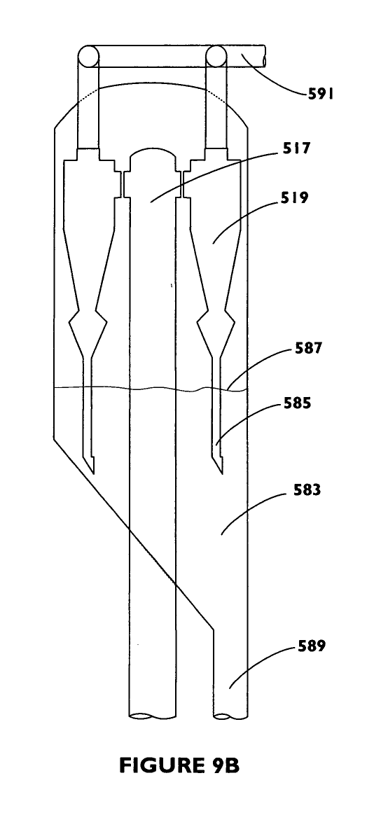

FIG. 9a is a process flow diagram of the present invention preferred embodiment biomass fast pyrolysis system 500 which allows for higher process efficiency and greater flexibility in controlling product characteristics such as initial boiling points, controlled moisture content, and flash points. Biomass vegetative material 501 is harvested and brought to the process in a chipped form. The biomass vegetative matter is dried and size reduced in a pre-processing step 503. The pre-processed biomass vegetative matter is pressurized by using various devices such as lock hoppers or tapered screws 505. The pressurized material is screw fed 507 into the non-recirculating riser reactor lower section 513 where it is contracted by hot heat carrier solids 509 which are fluidized by compressed syngas 511. The rapid heat up of the biomass vegetative material causes the release of its volatile gases which transport the resulting char and heat carrier solids up the non-recirculating riser reactor 515. These solids laden pyrolysis gases exit riser reactor upper section 517 to one or more cyclones 519. The cyclone(s) 519 separate(s) the char and heat carrier solids from the pyrolysis gases, conveying to a surge tank 521, where the level 527 is controlled by valve 525. The char laden heat carrier stream 529 is conveyed to the char combustor 531. A blower 555 is used to deliver compressed air 535 to the char combustor where the combustion of the char takes place leaving an ash particulate and thus reheating the heat carrying solids. The combustor air is preheated by a syngas fired indirect contact air preheater 557. Char combustor cyclones 533 are used to separate the resultant ash and heat carrier fines from the heat carrier stream. The resultant ash laden flue gases are exhausted from the process in stream 561. The reheated heat carrier solids dropped into a solids cooler 523 where air, stream 537, is used as the fluidizing agent, which elutriates the fines and completes the combustion of any remaining char, exhausting the dust laden flue gas to stream 539. The solid cooler is also used to take a condensate stream 541 preheated to near saturated conditions and generate a steam 547. The steam generation can be aided by the further use of syngas by incorporating an indirect fired pre-heater economizer 543 and an indirect fired super-heater 545. The warm heat carrier solids are returned by a downcomer 549 and flow controlled by a slide gate valve 551, used to control the non-recirculating riser reactor exit temperature 581. Make-up heat carrier 559 is added to the char combustor to replenish the fines lost in the char combustor cyclone and exhaust.

The pyrolysis gases exiting the riser cyclone 519 are rapidly cooled (to a temperature near the water dew point) by a quench agent (nitrogen, one of the multiple condenser steams where a high concentration of water is condensing out, or the product stream) in a baffled tank 563. The pyrolysis gases are further cooled in condenser 565 to condense out a lower molecular weight liquid stream. Both of these liquid streams are collected to form a liquid product stream 579. The syngas is compressed in compressor 569, and further cooled under higher pressure in cooler 571. The resultant aerosol laden gas stream is passed through a device 567 (coalescing filter or wet electrostatic precipitator) to coalesce the aerosols into a liquid stream which is added to the product stream. A controlled portion of the remaining syngas, stream 573, is recycled back to the non-circulating riser reactor lower section where it fluidizes the heat carrier solids entering this section. The liquid stream from the syngas compressor cooler is also combined with liquid product stream 579. A pressure regulating valve 575 is used to control system pressure, allowing the syngas to be exhausted as a product stream 577.

FIG. 9b shows a disengaging vessel 583, which is required if multiple cyclones were incorporated for FIG. 9a. This vessel is attached to the top of the riser 517. Multiple cyclones 519 are radially connected to the top of the riser. Each of the cyclone diplegs 585 is submerged below the solids level 587 in the lower section of the disengaging vessel. The lower section acts as a hopper for the heat carrier and char solids, discharging to a common downcomer 589. Each of the cyclone upflow gas exhausts are connected to a common pyrolysis gas duct 591.

### EXAMPLE 1

This example should be taken in conjunction with FIGS. 2,4, 5, 6 and 7, utilizing the physical structures and process steps set forth therein.

Filtercane biomass is farmed and harvested. Prior to entering the pyrolysis process steps, the biomass goes through the preparation processes of drying and pulverizing to create the dry powder material. Presses are needed if the biomass is wet or has high water content. Dryers and size reduction mills are utilized to reduce moisture content to preferably below 18% and 1 mm in size.

Once reduced to dry powder, the biomass feed needs to be pressurized to enter the reactor. Pressurization is achieved by screw feeder means with valving or sealing options to feed the biomass into the reactor under pressure.

The biomass feed enters the reactor, a non-circulating transport riser reactor of the type shown in FIG. 4 and described above, for fast pyrolysis (residence time under or well under 3 seconds, in some cases, less than 1 second—for preferred embodiments, residence time will be assumed to be between 1 and 2 seconds). The reactor uses recycled syngas as the hot blower. The syngas enters the base introduced above these inputs via the pressurized screw feeder. The syngas input creates inert acceleration so that the biomass intermixes with the syngas and heat carrier to a flow of about 60 feet per second at temperatures of about 700° F. to about 1100° F. A disengager at the top of the riser reactor releases hot syngas off the top via center feed cyclone disengagement, and releases char and heat carrier to a downpipe to a combustor unit. Thus, we do not recycle the heat carrier (and char) direct back to the riser reactor mixing section, as in earlier methods. Instead, we remove the heat carrier and char to a combustor and bed cooler before it is returned to the mixing section of our non-circulating transport riser reactor.

The combustor unit feeds the bed carrier solids back to the riser reactor and feeds other components to heat recovery. Steam, APC cleaned atmospheric gases and chars (ash) are removed. The ash is preferably used as fertilizer that goes back to the biomass farm.

The preferred bed carrier is olivine or equivalent, which is a magnesium silicon oxide. It has a higher agglomeration temperature by about 50° F. to 150° F. over others (silica, alumina). The pyrolysis gases are cooled to create a condensate liquid and a syngas energy stream.

The syngas coming off the riser reactor goes through a downstream cracker retarder high temperature condenser, 700° F. filter, and gas compression unit to yield liquid fuel product (combustion turbine grade synfuel). We cool to 475° C. to (900° F.) over a long time period (relative to prior art fast quench teachings) and then quench to about 370° C. to slow the thermal cracking.

Although particular embodiments of the invention have been described in detail herein with reference to the accompanying drawings, it is to be understood that the invention is not limited to those particular embodiments, and that various changes and modifications may be effected therein by one skilled in the art without departing from the scope or spirit of the invention as defined in the appended claims.

What is claimed is:

1. A biomass fast pyrolysis system for conversion of biomass vegetation to synthetic gas and liquid fuels, which comprises:
a) a non-circulating riser reactor for pyrolysis of biomass vegetation feedstock utilizing a heat carrier, said non-circulating riser reactor being physically structured and adapted to have a rate of reaction of at least 8,000 biomass vegetation feedstock lbs/hr/ft², utilizing a ratio of heat carrier to biomass vegetation feedstock of about 7:1 to about 11.5:1, said riser reactor having a base input region at its bottom, a central reaction region and an output region at its top, said riser reactor including a cyclone disengager at its output region for separation of pyrolysis resulting char and heat carrier from the pyrolysis product gases, said cyclone disengager having an output downcomer and an output upcomer, said cyclone disengager output downcomer being connected to and feeding into a side combustor unit, said riser reactor being a non-circulating riser reactor in that the heat carrier is not returned directly to the riser reactor from said cyclone disengager and travels first down said cyclone disengager output downcomer to said side combustor unit; and,
b) said side combustor unit for combusting pyrolysis resultant char and reheating said heat carrier said side combustor having a heat carrier downcomer connected to said base input region of said riser reactor.

2. The biomass fast pyrolysis system for conversion of biomass vegetation to synthetic gas and liquid fuels of claim 1 wherein said input region of said riser reactor includes separate biomass vegetation feedstock input and mixing gas input feedlines.

3. The biomass fast pyrolysis system for conversion of biomass vegetation to synthetic gas and liquid fuels of claim 2 wherein said biomass vegetation feedstock input feedline is located downstream from said mixing gas input feedline.

4. The biomass fast pyrolysis system for conversion of biomass vegetation to synthetic gas and liquid fuels of claim 2 wherein said synthetic gas input feedline is a manifolding feedline with a plurality of inputs.

5. The biomass fast pyrolysis system for conversion of biomass vegetation to synthetic gas and liquid fuels of claim 1 wherein said riser reactor has a predetermined maximum internal diameter with a height at least 10 times greater than said predetermined maximum internal diameter.

6. The biomass fast pyrolysis system for conversion of biomass vegetation to synthetic gas and liquid fuels of claim 1 wherein said cyclone disengager contains a plurality of cyclones.

7. The biomass fast pyrolysis system for conversion of biomass vegetation to synthetic gas and liquid fuels of claim 6 wherein said cyclone disengager contains a plurality of cyclones coupled such that exiting gases will pass sequentially through at least two cyclone units before exiting.

8. The biomass fast pyrolysis system for conversion of biomass vegetation to synthetic gas and liquid fuels of claim 1 wherein said side combustor unit is selected from the group consisting of a transport reactor combustor unit and a bubbling bed combustor unit.

9. The biomass fast pyrolysis system for conversion of biomass vegetation to synthetic gas and liquid fuels of claim 1 wherein said side combustor unit is a transport reactor combustor unit.

10. The biomass fast pyrolysis system for conversion of biomass vegetation to synthetic gas and liquid fuels of claim 9 wherein said side combustor unit is a transport reactor combustor unit and said cyclone disengager includes a surge control subunit at said cyclone disengager output downcomer.

11. The biomass fast pyrolysis system for conversion of biomass vegetation to synthetic gas and liquid fuels of claim 1 wherein said side combustor unit is a bubbling bed combustor unit.

12. The biomass fast pyrolysis system for conversion of biomass vegetation to synthetic gas and liquid fuels of claim 1 wherein said side combustor unit is a bubbling bed combustor unit including a lower combustion region and an upper freeboard region, said freeboard region including a plurality of cyclones with at least one output upcomer for exhaust, said combustor unit further including a preheated gas inlet at its combustion region and said combustor unit having a combustion unit downcomer connected to the input region of said riser reactor from said lower combustion region.

13. The biomass fast pyrolysis system for conversion of biomass vegetation to synthetic gas and liquid fuels of claim 12 wherein said freeboard region of said bubbling bed combustor unit contains a plurality of cyclones with outputs coupled such that exiting gases will pass through at least two cyclone units before exiting.

14. A biomass fast pyrolysis system for conversion of biomass vegetation to synthetic gas and liquid fuels, which comprises:
a) a non-circulating riser reactor for pyrolysis of biomass vegetation feedstock utilizing a heat carrier, said non-circulating riser reactor being physically structured and adapted to have a rate of reaction of at least 8,000 biomass vegetation feedstock lbs/hr/ft², utilizing a ratio of heat carrier to biomass vegetation feedstock of about 7:1 to about 11.5:1, said riser reactor having a base input region at its bottom, a central reaction region and an output region at its top, said riser reactor including a cyclone disengager at its output region for separation of pyrolysis resulting char and heat carrier from the pyrolysis product gases, said cyclone disengager having an output downcomer and an output upcomer, said cyclone disengager output downcomer being connected to and feeding into a side combustor unit, said riser reactor being a non-circulating riser reactor in that the heat carrier is not returned directly to the riser reactor from said cyclone disengager and travels first down said cyclone disengager output downcomer to said side combustor unit; and,
b) said side combustor unit for combusting pyrolysis resultant char and reheating said heat carrier said side combustor having a heat carrier downcomer connected to said base input region of said riser reactor; and,
c) separate biomass input feedline and mixing gas input feedline, wherein said biomass input feedline connected to said input region of said riser reactor includes back pressure control means to prevent pressure release from said riser reactor during operation.

15. The biomass fast pyrolysis system for conversion of biomass vegetation to synthetic gas and liquid fuels of claim 14 wherein said biomass vegetation feedstock input feedline is located downstream from said mixing gas input feedline.

16. The biomass fast pyrolysis system for conversion of biomass vegetation to synthetic gas and liquid fuels of claim 14 wherein said synthetic gas input feedline is a manifolding feedline with a plurality of inputs.

17. The biomass fast pyrolysis system for conversion of biomass vegetation to synthetic gas and liquid fuels of claim 14 wherein said riser reactor has a predetermined maximum internal diameter with a height at least 10 times greater than said predetermined maximum internal diameter.

18. The biomass fast pyrolysis system for conversion of biomass vegetation to synthetic gas and liquid fuels of claim 14 wherein said cyclone disengager contains a plurality of cyclones.

19. The biomass fast pyrolysis system for conversion of biomass vegetation to synthetic gas and liquid fuels of claim 18 wherein said cyclone disengager contains a plurality of cyclones coupled such that exiting gases will pass sequentially through at least two cyclone units before exiting.

20. The biomass fast pyrolysis system for conversion of biomass vegetation to synthetic gas and liquid fuels of claim 14 wherein said side combustor unit is selected from the group consisting of a transport reactor combustor unit and a bubbling bed combustor unit.

21. The biomass fast pyrolysis system for conversion of biomass vegetation to synthetic gas and liquid fuels of claim 14 wherein said side combustor unit is a transport reactor combustor unit.

22. The biomass fast pyrolysis system for conversion of biomass vegetation to synthetic gas and liquid fuels of claim 21 wherein said side combustor unit is a transport reactor combustor unit and said cyclone disengager includes a surge control subunit at said cyclone disengager output downcomer.

23. The biomass fast pyrolysis system for conversion of biomass vegetation to synthetic gas and liquid fuels of claim 14 wherein said side combustor unit is a bubbling bed combustor unit.

24. The biomass fast pyrolysis system for conversion of biomass vegetation to synthetic gas and liquid fuels of claim 23 wherein said side combustor unit is a bubbling bed combustor unit including a lower combustion region and an upper freeboard region, said freeboard region including a plurality of cyclones with at least one output upcomer for exhaust, said combustor unit further including a preheated gas inlet at its combustion region and said combustor unit having a combustion unit downcomer connected to the input region of said riser reactor from said lower combustion region.

25. The biomass fast pyrolysis system for conversion of biomass vegetation to synthetic gas and liquid fuels of claim 24 wherein said freeboard region of said bubbling bed combustor unit contains a plurality of cyclones with outputs coupled such that exiting gases will pass through at least two cyclone units before exiting.
